(19) United States
(12) Patent Application Publication
(10) Pub. No.: US 2014/0123401 A1
(43) Pub. Date: May 8, 2014

(54) Composition

(71) Applicants: Antonio Cordellina, Mira (IT); Raquel Lafuente Serra, Mira (IT); Alessandro Latini, Mira (IT)

(72) Inventors: Antonio Cordellina, Mira (IT); Raquel Lafuente Serra, Mira (IT); Alessandro Latini, Mira (IT)

(73) Assignee: Reckitt Benckiser N.V., WT Hoofddorp (NL)

(21) Appl. No.: 14/119,506

(22) PCT Filed: May 25, 2012
(86) PCT No.: PCT/GB2012/051185

§ 371 Date: Jan. 10, 2014

(30) Foreign Application Priority Data
May 27, 2011 (GB) 1108912.5

(51) Int. Cl. C11D 17/00

(52) U.S. Cl. CPC C11D 17/003
USPC 8/137; 510/337

(57) ABSTRACT

A liquid detergent composition having a thickening system/suspension system which comprises (a) an ionic salt in an amount of over 10 wt %.

This invention relates to aqueous liquid detergents, preferably for use as a laundry composition or in conjunction with a laundry detergent.

Liquid based laundry compositions have been known for many years. A major issue encountered with such compositions has been the achievement of a suitable viscosity for the liquid: the liquid has to be viscous enough so that any particles are suspended yet have a sufficiently high degree of flow for ease of manufacture and dispense by a consumer.

To achieve the desired rheology typically thickeners are used. These thickeners are rheology modifiers suitable for liquid detergents. They are used to associate a higher concentration of active ingredients and to aggregate them in a stable matrix.

Numerous thickening systems have been developed over the years but there is still room for improvement in such systems, particularly as regards cost effectiveness and environmental concerns.

Different kinds of thickener are commercially available. One class of thickener that is used extensively are those based upon polymeric-carboxylic acids and their salts.

Whilst generally these thickeners are highly effective one significant disadvantage in their use is that their efficacy is highly dependent on the pH and ionic strength of the liquid in which they are employed. Indeed the thickening effect of carboxylic acid based thickeners is only significant in alkaline solutions and/or solution having low ionic strength when the carboxylic acid based thickeners are in a dissociate state.

In such a condition the thickening mechanism is based on 2 main effects:

In an alkaline environment the carboxylic acid dissociates to carboxylate anions. As a result the electrostatic repulsion of the anions causes the stretching of the polymer chain. This phenomenon reduces the degrees of freedom of the structure in the liquid matrix.

Moreover the carboxylate anions interact with the hydrophilic heads of the surfactant micelles, creating a tri-dimensional network between the thickener backbone and the micelles (associative effect).

The result of these two effects in the right conditions is the increase of viscosity of the liquid.

It is therefore a primary object of this invention to develop stabilised laundry detergent composition (or a composition to be used in conjunction with a laundry detergent) which incorporates a low cost, but effective, thickening system over a broad range of conditions.

According to the first aspect of the present invention there is provided a liquid detergent composition having a thickening system/suspension system which comprises (a) an ionic salt in an amount of over 10 wt %.

With the thickening system of the present invention it has been found that superior thickening of a liquid detergent composition can be achieved. This thickening is such that small particles, even particles of clay (bentonite) or enzyme can be effectively suspended.

A further benefit deriving from the thickening system of the present invention is an associated increase of density (of the formulation being thickened). This has been found to be beneficial in the suspension of particles, which may have a higher density than the liquid matrix.

In this regard it has been found that the density of a typical (aqueous based) liquid detergent, (of no or low ionic salt content) is generally in the range 1.02 to 1.09.

In formulations wherein granules/speckles are incorporated and where it is desirable to suspend said granules/speckles (for a number of reasons including even distribution within the formulation for even dosing and stability) an increase in density of the formulation can be desirable (especially where the granules/speckles have a density higher than that if the un-modified liquid matrix). If for example, it is desired to prepare a formulation containing granules/speckles of an enzyme/clay (e.g. ones which comprises bentonite (density about 1.80 g/cm3)), the addition of sodium chloride has been found not only to create a structure in the liquid and increases viscosity, but also to adjust the density of the matrix much closer to that of the bentonite granules, e.g. to about 1.80 g/cm3, making the stability of the suspension much better.

According to the second aspect of the present invention there is provided a liquid detergent composition having a thickening system/suspension system which comprises an ionic salt in an amount of over 10 wt % and suspended particles of clay and/or enzyme.

Preferably the composition (the liquid phase) has a density of over 1.2 g/cm3, more preferably the composition has a density of 1.2 to 3 g/cm3, more preferably the composition has a density of 1.4 to 2.5 g/cm3, more preferably the composition has a density of 1.5 to 2 g/cm3, most preferably the composition has a density of about 1.8 g/cm3.

Preferably the particles have a density of over 1.2 g/cm3, more preferably the particles have a density of 1.2 to 3 g/cm3, more preferably the particles have a density of 1.4 to 2.5 g/cm3, more preferably the particles have a density of 1.5 to 2 g/cm3, most preferably the particles have a density of about 1.8 g/cm3

Generally the density of the composition (the liquid phase) is tailored to be similar to/identical to the density of the particles.

Preferably the composition comprises from 0.001% to 99.99%, preferably 0.001% to 20%, preferably 4% to 18%, e.g. most preferably about 4.5% or 13%, by weight, of bleach. The bleach is preferably peroxide bleach, most preferably hydrogen peroxide. Peroxide sources other than H₂O₂ can be used.

Preferably the composition comprises a surfactant. Where present the composition comprises from 0.001% to 99.99%, preferably 0.05% to 15%, e.g. about 7%, by weight of surfactant.

The surfactant is, for example, an anionic or nonionic surfactant or mixture thereof (most preferably a non-ionic surfactant). The nonionic surfactant is preferably a surfactant having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Examples of other non-ionic surfactants include higher aliphatic primary alcohol containing about twelve to about 16 carbon atoms which are condensed with about three to thirteen moles of ethylene oxide.

Other examples of nonionic surfactants include primary alcohol ethoxylates (available under the Neodol trade name from Shell Co.), such as C₁₁ alkanol condensed with 9 moles of ethylene oxide (Neodol 1-9), C₁₂₋₁₃ alkanol condensed with 6.5 moles ethylene oxide (Neodol 23-6.5), C₁₂₋₁₃ alkanol with 9 moles of ethylene oxide (Neodol 23-9), C12-15 alkanol condensed with 7 or 3 moles ethylene oxide (Neodol 25-7 or Neodol 25-3), C₁₄₋₁₅ alkanol condensed with 13 moles ethylene oxide (Neodol 45-13), C₉₋₁₁ linear ethoxylated alcohol, averaging 2.5 moles of ethylene oxide per mole of alcohol (Neodol 91-2.5), and the like.

Other examples of nonionic surfactants suitable for use in the present invention include ethylene oxide condensate products of secondary aliphatic alcohols containing 11 to 18 carbon atoms in a straight or branched chain configuration condensed with 5 to 30 moles of ethylene oxide. Examples of commercially available non-ionic detergents of the foregoing type are C₁₁₋₁₅ secondary alkanol condensed with either 9 moles of ethylene oxide (Tergitol 15-S-9) or 12 moles of ethylene oxide (Tergitol 15-S-12) marketed by Union Carbide, a subsidiary of Dow Chemical.

Octylphenoxy polyethoxyethanol type nonionic surfactants, for example, Triton X-100, as well as amine oxides can also be used as a nonionic surfactant in the present invention.

Other examples of linear primary alcohol ethoxylates are available under the Tomadol trade name such as, for example, Tomadol 1-7, a C₁₁ linear primary alcohol ethoxylate with 7 moles EO; Tomadol 25-7, a C₁₂-C₁₅ linear primary alcohol ethoxylate with 7 moles EO; Tomadol 45-7, a C₁₄-C₁₅ linear primary alcohol ethoxylate with 7 moles EO; and Tomadol 91-6, a C₉-C₁₁ linear alcohol ethoxylate with 6 moles EO.

Other examples of linear primary alcohol ethoxylates are available under the Lutensol trade name such as, for example, Lutensol A3N, a C₁₃₋₁₅ linear primary alcohol ethoxylate with 3 moles EO; Lutensol LA60, a C₁₃₋₁₅ linear primary alcohol ethoxylate with 7 moles EO. Also Genapol such as, for example, Genapol LA3, a C₁₃₋₁₅ linear primary alcohol ethoxylate with 3 moles EO; Genapol LA070, a C₁₃₋₁₅ linear primary alcohol ethoxylate with 7 moles EO

Tomadol 45-7, a C₁₄-C₁₅ linear primary alcohol ethoxylate with 7 moles EO; and Tomadol 91-6, a C₉-C₁₁ linear alcohol ethoxylate with 6 moles EO.

Other nonionic surfactants are amine oxides, alkyl amide oxide surfactants.

Preferred anionic surfactants are frequently provided as alkali metal salts, ammonium salts, amine salts, aminoalcohol salts or magnesium salts. Contemplated as useful are one or more sulfate or sulfonate compounds including: alkyl benzene sulfates, alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Other surfactants which may be used are alkyl naphthalene sulfonates and acyl/oleoyl sarcosinates and mixtures thereof.

The composition may various optional ingredients, including enzymes, builders, solvents, dye transfer inhibition agents, dye catchers, preservatives, antioxidants, anti-static agents, fragrances, odour absorbing components, optical brighteners, acidifying agents, alkalizing agents, thickeners (e.g. hydroxyethylcellulose and/or xanthan gum).

The pH range of the fabric treatment composition is typically from about 1 to about 8, e.g. from 3 to 5, more preferably from 4 to 5. It has been noted that at these pH ranges the beneficial thickening interaction between the semi-polar nonionic surfactant and the nonionic surfactant is particularly enhanced.

The viscosity of the composition is ideally at least 800 cPs, more preferably at least 1000 cPs

The composition is preferably used in a washing machine cycle and/or as a pre-soaker/soaker in a clothes cleaning operation, e.g. as a fabric treatment composition.

The invention will be illustrated with reference to the following non-limiting Examples.

### EXAMPLES

Products

| Raw Materials | (wt %) |
|---|---|
| Sulphonic acid 96% | 11.5000 |
| Coconut fatty acids | 2.2300 |
| Nonionic Surfactant | 8.8000 |
| (C₁₂₋₁₆ + 7EO) | |
| Anionic Surfactant | 15.9300 |
| (ELS 3M 26%) | |
| NaOH 48% | 4.2000 |
| TEA 99% | 1.0000 |
| DTPMP C 7Na 41.2% | 1.5625 |
| Citric acid 50% | 1.4651 |
| BIT @20% | 0.1500 |
| Sodium sulphite | 0.1000 |
| Borax | 0.8000 |
| MPG | 2.5000 |
| Optical brightener | 0.0320 |
| Protease | 0.7800 |
| Amylase | 0.5000 |
| NaCl | 10.4000 |
| Dye | 0.0013 |
| Fragrance | 0.8300 |
| WATER | 37.2191 |

1. A liquid detergent composition having a thickening system/suspension system which comprises
(a) an ionic salt in an amount of over 10 wt %.

2. A liquid detergent composition having a thickening system/suspension system which comprises an ionic salt in an amount of over 10 wt % and suspended particles of clay and/or enzyme.

3. A composition according to claim 2, wherein the composition (the liquid phase) has a density of over 1.2 g/cm³.

4. A composition according to claim 2, wherein the particles have a density of over 1.2 g/cm³.

5. A composition according to claim 3, wherein the density of the composition (the liquid phase) is similar to/identical to the density of the particles.

6. A laundry washing/fabric treatment process operation which process comprises the step of:
contacting the laundry or fabric with a composition according to claim 1.

7. A composition according to claim 4 wherein the density of the composition (the liquid phase) is similar to/identical to the density of the particles.

8. A composition according to claim 3, wherein the composition (the liquid phase) has a density of over 1.2 to 3 g/cm³.

9. A composition according to claim 8, wherein the composition (the liquid phase) has a density of 1.4 to 2.5 g/cm³.

10. A composition according to claim 9, wherein the composition (the liquid phase) has a density of 1.5 to 2 g/cm³.

11. A composition according to claim 10, wherein the composition (the liquid phase) has a density of about 1.8 g/cm³.

12. A composition according to claim 4, wherein the particles have a density of 1.2 to 3 g/cm³.

13. A composition according to claim 12, wherein the particles have a density of 1.4 to 2.5 g/cm³.

14. A composition according to claim 13, wherein the particles have a density of 1.5 to 2 g/cm³.

15. A composition according to claim 14, wherein the particles have a density of about 1.8 g/cm³.

16. A liquid laundry detergent composition comprising the liquid detergent composition according to claim 1.

17. A liquid fabric pre-soak composition comprising the liquid detergent composition according to claim 1.
